(19) United States
(12) Patent Application Publication
(10) Pub. No.: US 2020/0010489 A1
(43) Pub. Date: Jan. 9, 2020

(54) ZWITTERIONIC SILATRANE-BASED MATERIAL AND ANTIFOULING SUBSTRATE CONTAINING SAME

(71) Applicant: National Central University, Taoyuan (TW)

(72) Inventors: Chun-Jen HUANG, Taoyuan (TW); Ya-Yun ZHENG, Changhua County (TW); Hsiu-Pang YEH, Tainan (TW)

(21) Appl. No.: 16/284,710

(22) Filed: Feb. 25, 2019

(30) Foreign Application Priority Data
Jul. 5, 2018 (TW) 107123319

(51) Int. Cl. C07F 7/18; C09D 7/63

(52) U.S. Cl. CPC C07F 7/1804; C09D 7/63

(57) ABSTRACT

The present invention provides a zwitterionic silatrane-based material and an antifouling substrate containing the same, wherein zwitterionic silatrane-based material has a structure as shown in Formula (I):

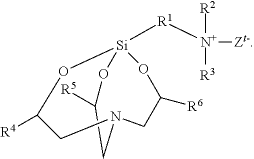

### FIELD OF THE INVENTION

The present invention relates to a coating material, in particular to a zwitterionic silatrane-based material, and an antifouling substrate containing the zwitterionic silatrane-based material.

### BACKGROUND OF THE INVENTION

Surface treatment is a technique for protecting a substrate material by modifying the surface of the material or coating a layer of other materials, and is one of the indispensable and important techniques in modern process techniques.

For example, in the field of biomedical engineering, for a drug storage container, if it is desirable to prolong the shelf life of a stored drug, one of the key points is to prevent the drug from causing components of a packaging container to be dissolved out and affect the drug efficacy. Therefore, the surfaces of packaging containers for some special drugs are treated to prevent the drugs from directly contacting container walls of the packaging containers.

Moreover, implantable or invasive medical instruments are prone to non-specific adsorption of biomolecules due to the contact with body fluids such as blood or tissues. In particular, the implantable medical devices are prone to problems such as blood clots, blood clotting reactions, or bacterial infections because of long exposure to blood. The above problems can also be overcome by surface treatment techniques such as modifying the surface of an implantable or invasive medical material with a coating to resist non-specific adsorption.

Specifically, the prior art US 2015/0335823 A1 discloses a method of controlling the deposition uniformity of a medical cartridge or syringe to form a uniform barrier coating on a cylindrical interior surface by plasma enhanced chemical vapor deposition (PECVD). The specific technical means of the above application is to provide a magnetic field in at least a portion of a cavity, the magnetic field having orientation and field intensity, thereby effectively improving the uniformity of plasma modification on the inner surface of the cavity and solving the problem that currently expensive, complex and sensitive drugs are affected by packaging containers of the drugs and the drug efficacies are impaired.

However, in addition to the above-described method for uniformizing a barrier coating in manner of providing a magnetic field, organosilanes have been considered to be effective and robust modifying materials in various substrates that have been used for decades. However, the problem of easy hydrolysis of organosilane functional groups remains to be solved, and it is apparent that there is still much room for improvement in the field of surface treatment.

### SUMMARY OF THE INVENTION

A main objective of the present invention is to solve the problem that an implantable or invasive medical device is prone to cause non-specific adsorption of biomolecules.

To fulfill said objective, the present invention provides a zwitterionic silatrane-based material having a Formula (I):

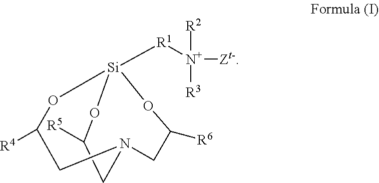

In the Formula (I), Z^{t-} is R⁷—SO₃⁻, R⁷—CO₂⁻, R⁷—OPO₃²⁻, R⁷—PO₃²⁻ or R⁷—OP(═O)(R)O⁻; R is an aliphatic, aromatic, branched, linear, cyclic or heterocyclic group; structures of R, R¹, R², R³, and R⁷ are independently selected from a group consisting of aliphatic, aromatic, branched, linear, cyclic, and heterocyclic groups; R⁴, R⁵ and R⁶ are independently selected from a group consisting of methyl (Me), H, ethyl (Et), and CH₂Cl.

In an embodiment of the present invention, Z^{t-} may be R⁷—SO₃⁻.

In an embodiment of the present invention, R may have 20 carbons or less, specifically may be an aliphatic series having 20 carbons or less, more specifically could be methyl, ethyl, propyl or butyl.

In an embodiment of the present invention, R, R¹, R², R³, and R⁷ are independently selected from the group consisting of a C1-C20 alkyl group, a C2-C20 alkenyl group, and a C2-C20 alkynyl group.

In an embodiment of the present invention, R² and R³ may be the same, for example, may be methyl, however, in other embodiments, R² and R³ may also be different.

In an embodiment of the present invention, the zwitterionic silatrane-based material comprises a structure as shown in a Formula (II):

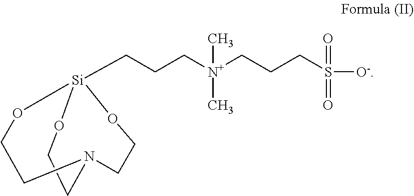

Meanwhile, the present invention discloses an antifouling substrate, comprising a base layer and a coating layer. The base layer comprises a hydroxyl-containing surface; the coating layer is formed by coating the hydroxyl-containing surface of the base layer with the zwitterionic silatrane-based material, such that Si—O—Si bonds are formed between the zwitterionic silatrane-based material and the base layer and then Si—O—Si bonds are grafted onto the base layer in order. The zwitterionic silatrane-based material comprises a structure as shown in a Formula (I):

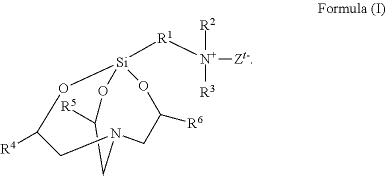

in the formula (I), Z^{t-} is R⁷—SO₃⁻, R⁷—CO₂⁻, R⁷—OPO₃²⁻, R⁷—PO₃²⁻ or R⁷—OP(═O)(R)O⁻; the structures of R, R¹, R², R³, and R⁷ are independently selected from the group consisting of aliphatic, aromatic, branched, linear, cyclic, and heterocyclic groups; R⁴, R⁵ and R⁶ are independently selected from the group consisting of methyl (Me), H, ethyl (Et), and CH₂Cl.

According to the zwitterionic silatrane-based material of the present invention, wherein silatrane is a tricyclic caged symmetrical structure formed by taking an N—Si bond as an axis, which is more stable than a conventional silane structure, and is not easily hydrolyzed and is easily preserved. Therefore, the material of the present invention not only breaks through the problem of surface aggregation and unevenness caused by easy hydrolysis of silane functional groups, but also maintains the property of good anti-non-specific adsorption of amphoteric double ions, has a great potential as an amphoteric double-ion anti-fouling coating and is of a major development in the field of medical engineering.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A shows the results of chemical stability of SBSi and SBSiT by Fourier transform infrared spectroscopy (FTIR).

FIG. 1B is photographs of solids of SBSiT and SBSi before and after storage for 24 hours.

FIG. 2 shows a result of a contact angle test of the antifouling substrate of the present invention.

FIG. 3 shows a result of nuclear magnetic resonance (NMR) spectroscopy in which the hydrolysis of silane in a MeOD solution containing 2% by volume of acetic acid is traced by 1H NMR.

FIG. 4A shows an atomic force microscope result of a Control 1 of the present invention.

FIG. 4B shows an atomic force microscope result of a coating layer in Embodiment 2 of the present invention.

FIG. 4C shows an atomic force microscope result of a coating layer in Comparative Example 1 of the present invention.

FIG. 4D shows an atomic force microscope result of a coating layer in Comparative Example 2 of the present invention.

FIG. 5 shows a result of measuring the thickness of the coating layer of the antifouling substrate by an ellipsometry method.

FIG. 6 shows the results of cytotoxicity tests for SBSiT and SBSi.

FIG. 7A shows the results of testing the antifouling substrate by fluorescent dye label.

FIG. 7B is a quantitative result chart of FIG. 7A.

FIG. 8A shows a frequency change result of the coating layer of the antifouling substrate by using a multifunctional high-precision quartz microbalance.

FIG. 8B shows a measurement result of the dissipative change of the coating layer of the antifouling substrate by using a multifunctional high-precision quartz microbalance.

### DETAILED DESCRIPTION OF THE PREFERRED EMBODIMENTS

A zwitterionic material with a silatrane and an antifouling substrate formed by using the above material as a coating layer of the present invention are described below with reference to the drawings.

The zwitterionic silatrane-based material in the present invention comprises a structure as shown in a Formula (I):

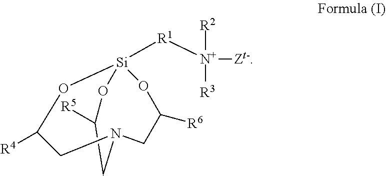

in which, Z^{t-} is R⁷—SO₃⁻, R⁷—CO₂⁻, R⁷—OPO₃²⁻, R⁷—PO₃²⁻ or R⁷—OP(═O)(R)O⁻; structures of R, R¹, R², R³, and R⁷ are independently selected from a group consisting of aliphatic, aromatic, branched, linear, cyclic, and heterocyclic groups; R⁴, R⁵ and R⁶ are independently selected from a group consisting of methyl (Me), H, ethyl (Et), and CH₂Cl.

In an embodiment, the present invention, Z^{t-} may be R⁷—SO₃⁻; R may have 20 carbons or less, specifically may be an aliphatic series having 20 carbons or less, more specifically could be methyl, ethyl, propyl or butyl. In an embodiment of the present invention, R, R¹, R², R³, and R⁷ are independently selected from the group consisting of a C1-C20 alkyl group, a C2-C20 alkenyl group, and a C2-C20 alkynyl group.

In an embodiment of the present invention, R² and R³ may be the same, for example, may be methyl. However, in other embodiments, R² and R³ may also be different.

Synthesis of Zwitterionic Silatrane-Based Material

22.8 mmol of (N,N-Dimethylaminopropyl)trimethoxysilane (DMASi) and 24.03 mmol of triethanolamine (TEOA) dissolved in methylbenzene are placed in a flask, and reacted under stirring at 110° C. for 30 hours reaction under a nitrogen atmosphere.

Next, the flask containing the above solution is kept at room temperature for 1 hour, and after adding sufficiently cooled n-pentane, the solutions are evaporated in vacuum to obtain a white precipitate. The white precipitate is washed with cooled n-pentane and collected by centrifugation at 9000 rpm for 5 minutes, and analyzed as (N,N-Dimethylaminopropyl) silatrane (DMASiT) with a yield of 66%.

3.84 mmol of DMASiT and 3.84 mmol of 1,3-propanesultone are dissolved in 4 mL of anhydrous acetone to obtain a solution, and the solution is mixed and stirred for 6 hours at room temperature under nitrogen to react and obtain a white product. The white product is washed with anhydrous acetone and collected by centrifugation at 9000 rpm for 5 minutes. The white product is dried in vacuum to obtain zwitterionic sulfobetaine silatrane (SBSiT) with a yield of 83%.

The reaction formula is as follows:

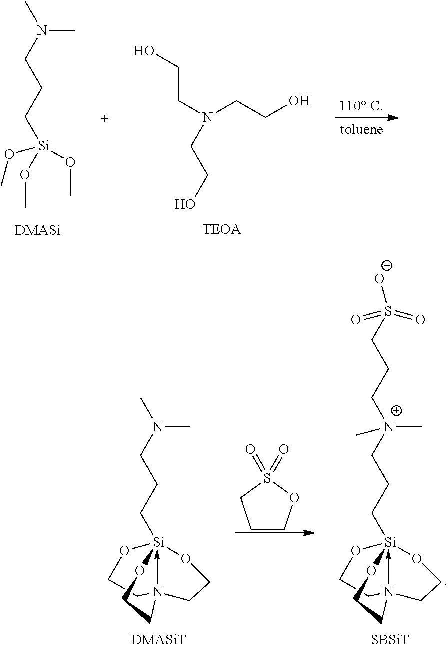

As a control, sulfobetaine silane (SBSi) is also synthesized here according to a conventional method. A preparation method of SBSi is as follows: 24 mmol of DMASi and 25 mmol of 1,3-propanesultone are dissolved in 25 ml of anhydrous acetone and stirred at room temperature for 6 hours under nitrogen. A white solid product on a filter after filtration of the above mixed solution is washed with acetone, and then dried in vacuum to obtain SBSi with a yield of 65%.

Chemical Stability Test

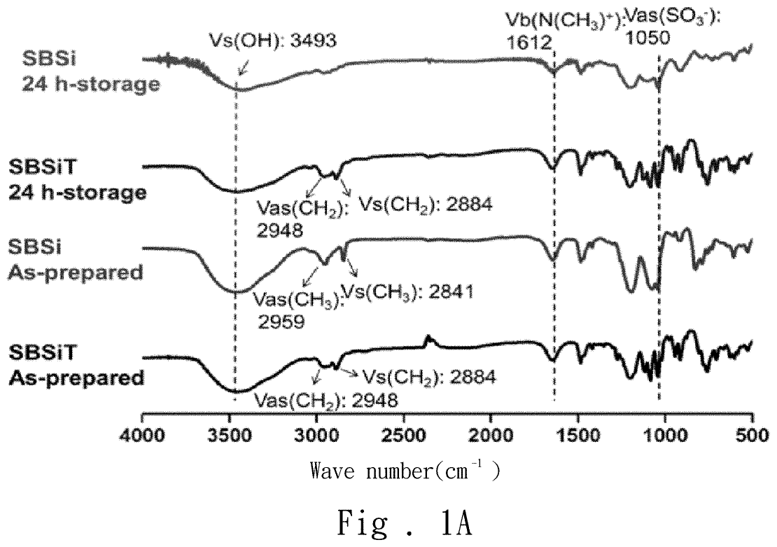

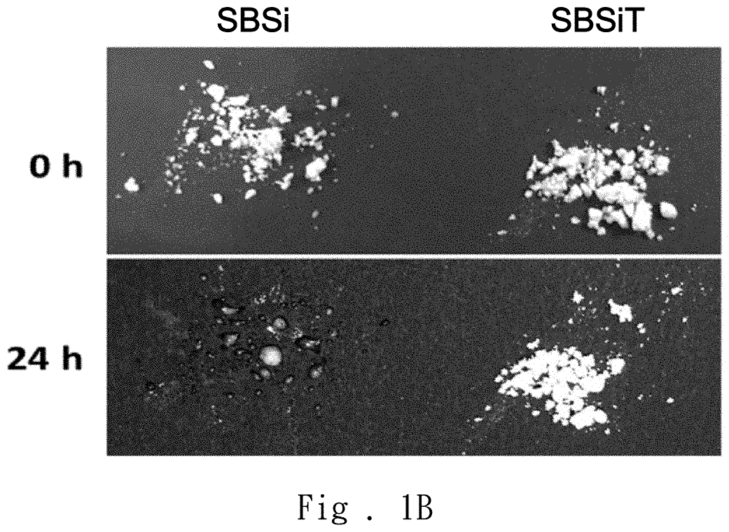

The dry solid powders of SBSi and SBSiT obtained above are placed in a laboratory environment (RH=79%, temperature=24° C.) for 24 hours, and the chemical stabilities of SBSi and SBSiT are examined by Fourier transform infrared spectroscopy (FTIR). Referring to FIG. 1A, signals is centered at 1050 and 1612 cm⁻¹ corresponding to Vas(SO3⁻) and Vb(N(CH3)⁺), respectively, so as to ensure that all samples have a sulfobetaine moiety.

In order to compare the integrity of methoxyl and silylcyclopentane, signals of SBSiT from Vs(CH₂)(2884 cm⁻¹) and Vas(CH₂)(2948 cm⁻¹) as well as signals of SBSi from Vs(CH₃)(2841 cm⁻¹) and Vas(CH₂)(2959 cm⁻¹) are compared, and the results show that the spectra of SBSiT before storage for 24 hours (SBSiT As-prepared) and after storage for 24 hours (SBSiT 24 h-storage) are almost the same, while the absorption intensity of Vs(CH₃) and Vas(CH₂) of SBSi after storage for 24 hours (SBSi 24 h-storage) is significantly lower than that before storage for 24 hours (SBSi As-prepared).

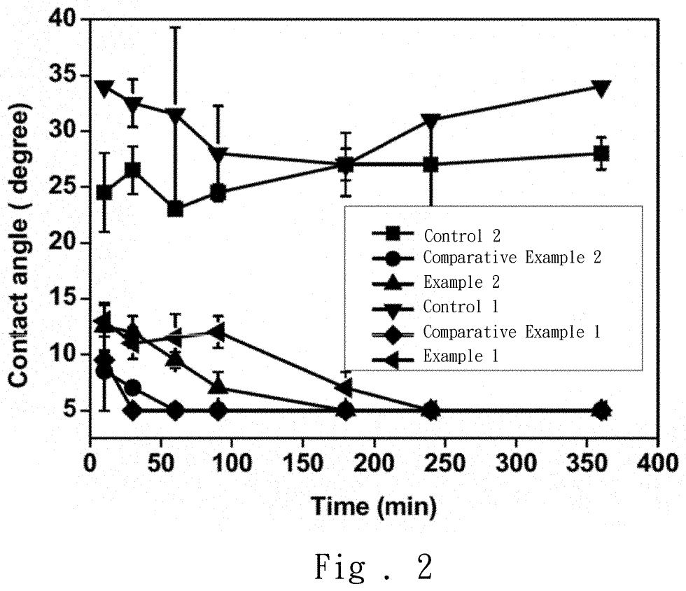

Further referring to FIG. 2B, photos of SBSiT and SBSi solids are displayed, in which, after storage for 24 hours, SBSi is clearly deliquescent and exhibits its hygroscopic properties. Conversely, SBSiT remains dry powdered when exposing under a moisture environment, thereby indicating that SBSiT is not sensitive to water and is more stable than SBSi.

Hydrophilicity Test

A substrate is sequentially washed in an ultrasonic treatment bath of 0.1% SDS, acetone, and ethanol for 10 minutes respectively, then dried in a nitrogen stream, and exposed the substrate to O₂ plasma in a plasma cleaner (PDC-001, Harrick Plasma, NY) at a power of 10.5 W for 10 minutes twice to remove traces of contaminants from the surface for use as a base layer. Regarding the material of the substrate, such as a glass substrate, a silicon wafer, or the like, it may be used as the base layer of the present invention as long as it has a hydroxyl group, no matter it has a hydroxyl group itself or has a hydroxyl group obtained by other treatments.

The base layers are immersed in 5 mM of SBSiT or SBSi coating solution containing 10% by volume of H₂O, and heated at 60° C. for 4.5 hours.

Next, the base layers are removed from the SBSiT or SBSi coating solution to form a coating layer on the base layers, then cleaned in an ultrasonic treatment bath of ethanol and dried in a nitrogen stream, and placed in an oven at 70° C. and baked for 1 hour. Since the base layers have a hydroxyl group, after the base layers are in contact with the SBSiT or SBSi coating solution, the coating solutions are hydrolyzed and condensed with the base layers to form Si—O—Si bonds, thereby obtaining an SBSiT antifouling substrate (Embodiment 1) and an SBSi anti-fouling substrate (Comparative Example 1).

According to the present embodiment, in order to accelerate the hydrolysis process, 2% acetic acid by volume is added to the coating solutions. It is found experimentally that, after a SBSiT solution containing 2% acetic acid by volume reacts with the 60° C. washed base layer to form a super-hydrophilic coating having a contact angle of <5° in 3-hour reaction (“Embodiment 2” in FIG. 2). However, the surface coating of the SBSiT solution without adding acetic acid takes 4 hours to achieve the superhydrophilicity (refer to “Embodiment 1” in FIG. 2).

Due to the rapid hydrolysis of the silane group of SBSi in ethanol, SBSi is allowed to deposit rapidly on the glass, so the superhydrophilic coating can be obtained within 1 hour regardless of whether an acid is added. Please refer to groups of “Comparative Example 1” in FIG. 2. (no acetic acid is added) and “Comparative Example 2” (acetic acid is added).

In this experiment, the base layer (“Control 1”) which is not in contact with any coating solution, and the base layer (“Control 2”) which is in contact with acetic acid are compared with Comparative Example 1, Comparative Example 2, Embodiment 1, and Embodiment 2, see FIG. 2.

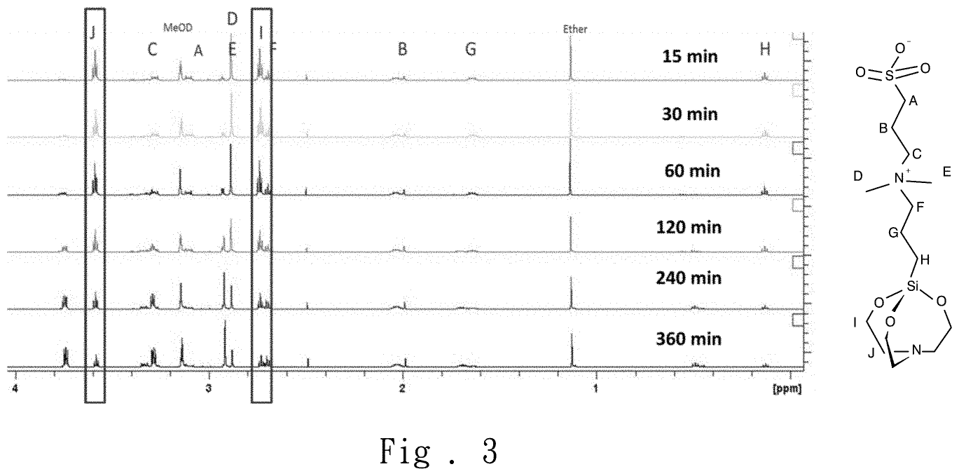

It should be supplementarily noted that the above-mentioned acid is found to increase the hydrolysis rate of silatrane. Please refer to FIG. 3, when 1H nuclear magnetic resonance (NMR) is used to trace the hydrolysis of silane in the MeOD solution containing 2% acetic acid by volume, compared with a D₂O solution, it is found that the signal intensity of silacyclopentadiene groups (positions: I and J) decreases over time, and the hydrolysis proceeds rapidly, which is showing a better sensitivity of SBSiT to acid. Obviously, the addition of an acid during the reaction allows rapid separation of TEOA from a silole ring to expose silanol groups, thereby promoting chemical conjugation of SBSiT on silica.

Further, for convenience of description, the controls, the comparative examples, and the embodiments described in the following series of experimental tests are defined as shown in Table 1 below.

TABLE 1

| | Definition |
|---|---|
| Control 1 | The base layer that is not in contact with any coating |
| | solution |
| Control 2 | The base layer treated with an acidic solution |
| Comparative | The base layer treated with SBSi |
| Example 1 | |
| Comparative | The base layer treated with SBSi containing an acidic |
| Example 2 | solution |
| Embodiment 1 | The base layer treated with SBSiT |
| Embodiment 2 | The base layer treated with SBSiT containing an acidic |
| | solution |

Flatness Test

In order to test the flatness of the anti-fouling substrates, an atomic force microscope (AFM) and an ellipsometry are used to study the surface morphology and thickness of the coating layer in each anti-fouling substrate in Table 1.

First, the AFM results show that the coating layer in Embodiment 2 is almost as flat as the above-mentioned Control 1 that is not in contact with any coating solution, and the root mean square (RMS) roughness (Rq) values thereof are 4.4 and 5.4, respectively, thereby showing that the SBSiT coating layer has good uniformity. Slow hydrolysis of the silatranyl groups causes the SBSiT molecules to be grafted onto a surface of the base layer in order, by forming Si—O—Si bonds with the base layer.

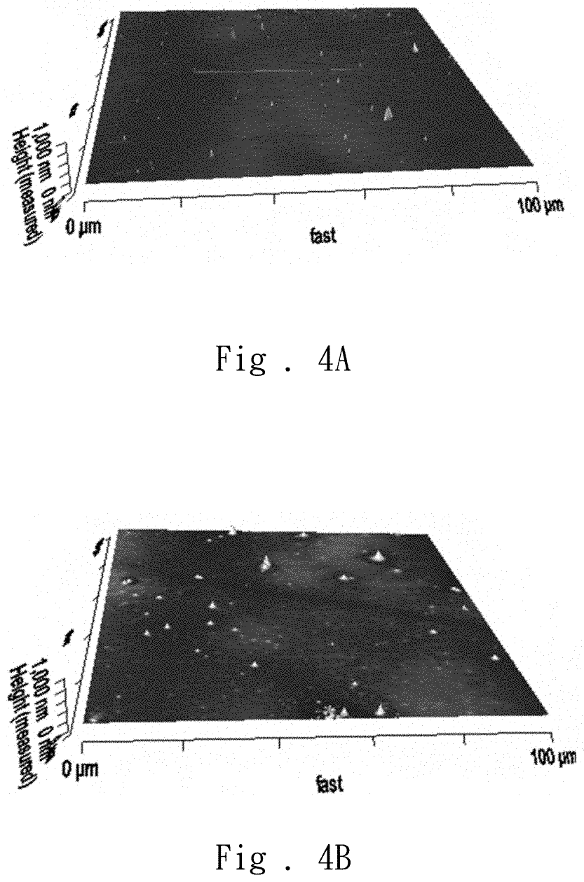

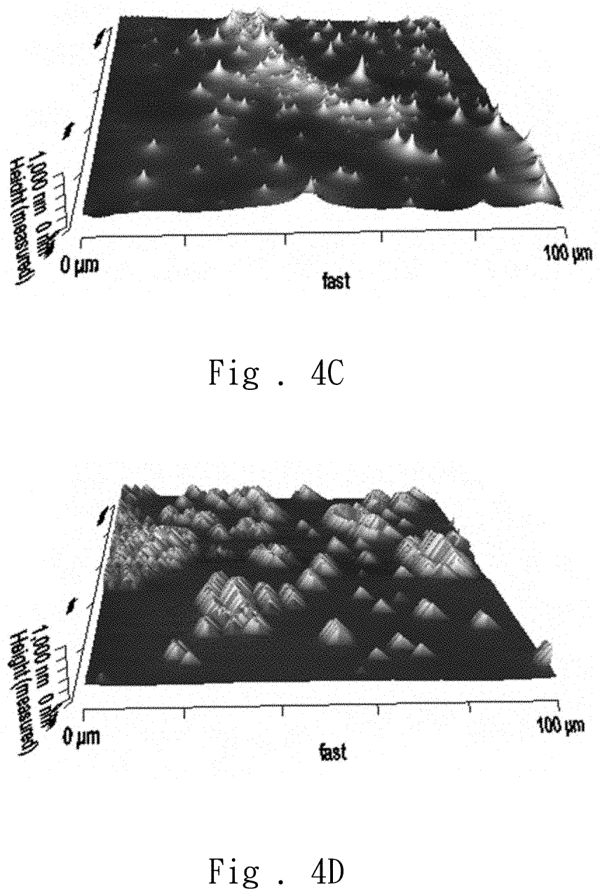

However, abundant microparticles appear on the surfaces of Comparative Example 1 and Comparative Example 2 treated with the SBSi coating solution containing acetic acid or containing no acetic acid. FIG. 4C and FIG. 4D show results of Comparative Example 1 and Comparative Example 2, respectively, and the root mean square (RMS) roughness (Rq) values thereof are as high as 66.5 and 112.6.

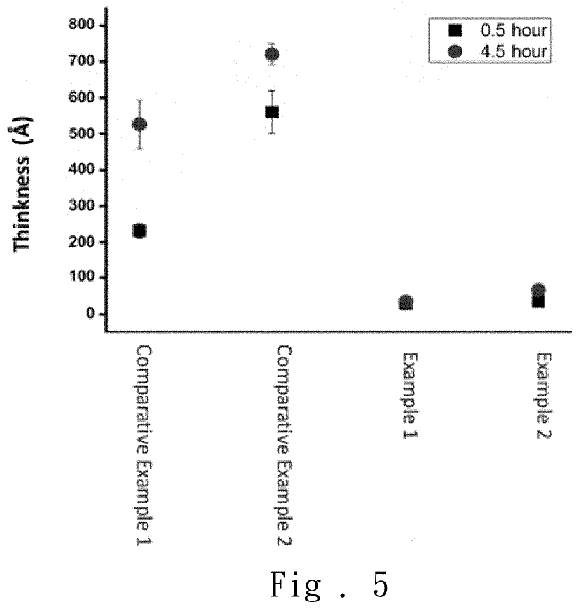

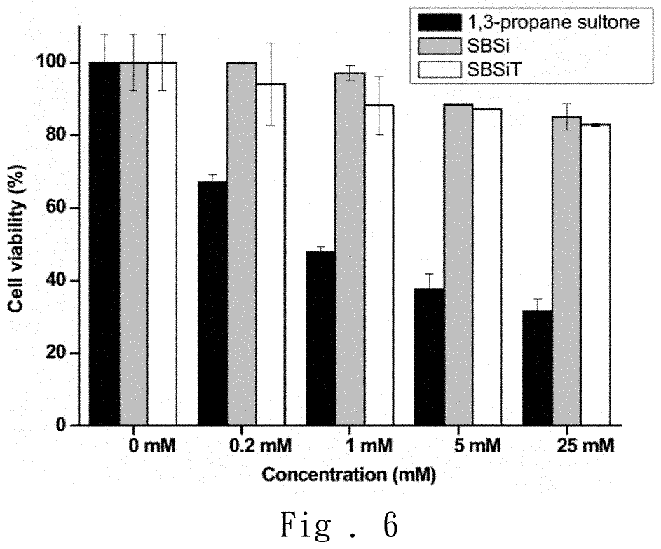

Further, the thickness of the coating layer of each of the antifouling substrates is measured by ellipsometry. Referring to FIG. 5, it is obvious that Comparative Example 2 has a higher coating thickness than the other groups. After deposition for 4.5 hours, the coating thickness is about 721±29 Å. In comparison, the coating thickness of Embodiment 2 under the same treatment time is only 650±11 Å. More importantly, the thickness of the coating of Embodiment 2 does not increase significantly over deposition time, which means a stepwise reaction of the silane with silanol groups on the surface to avoid formation of crosslinked polycyclosilane. Therefore, the slow hydrolysis of SBSiT facilitates controlled deposition of the anti-fouling coating while achieving good uniformity and thickness.

Cytotoxicity Test

In order to test the potential of antifouling coatings applied in the field of biomedical engineering, cytotoxicity tests are performed on the previously synthesized SBSi and SBSiT.

SBSi, SBSiT and 1,3-propanesultone (as a toxic comparative) are dissolved in a medium at a concentration of 0.2 to 25 mM, respectively. After incubation of the above medium with NIH-3T3 fibroblasts for 24 hours, the cell activity is detected by cell viability performing analysis on (3-(4,5-Dimethylthiazol-2-yl)-2,5-diphenyltetrazolium bromide MTT).

As shown in FIG. 6, compared to the toxic comparative (1,3-propanesultone), both groups of NIH-3T3 fibroblasts under SBSi and SBSiT concentrations of 25 mM can be maintained at a viability greater than 80%. It is apparent that both SBSi and SBSiT coatings have good biocompatibility.

Antibacterial Test Grain-negative Escherichia coli (E. coli) and Gram-positive Staphylococcus epidermidis (S. epidermidis) are treated to the anti-fouling substrate of Table 1 for 4.5 hours, and live/dead bacteria adhered on the coatings are calibrated with fluorescent dye, and therefore, the degree of bacterial contamination is detected.

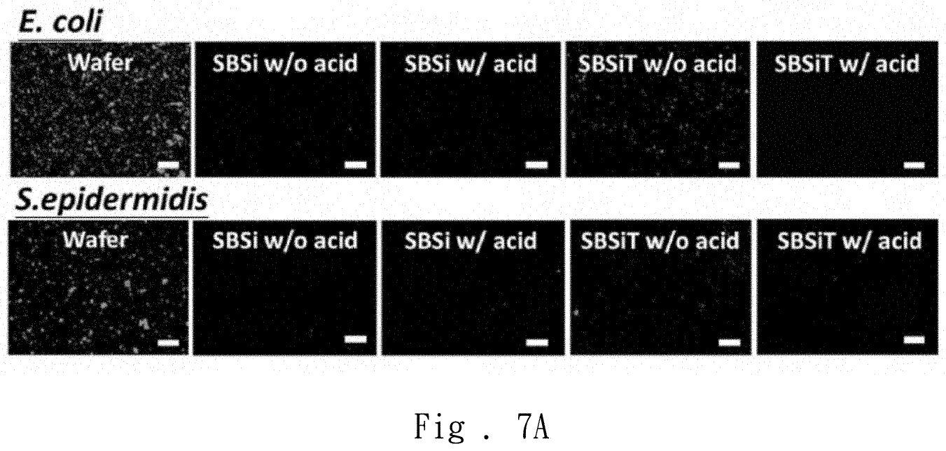

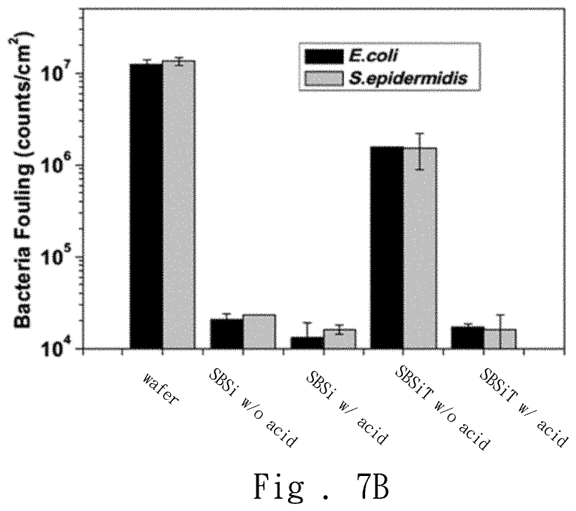

Please refer to FIG. 7A and the quantitative result diagram of FIG. 7B, as described in the prior art, the contamination degrees of the coatings of the Comparative Example 1 (SBSi w/o acid) and Comparative Example 2 (SBSi w/ acid), are reduced by 99% or more respectively compared with the Control 1 (wafer).

Embodiment 1 (SBSiT w/o acid) and Embodiment 2 (SBSiT w/ acid) each have a better antibacterial effect than Control 1, and especially the anti-fouling substrate of Embodiment 2 (SBSiT w/ acid) can resist bacterial contamination and can achieve an effect similar to that of SBSi anti-fouling substrate.

Structural Stability Test

In this experiment, a multifunctional high-precision quartz microbalance QCM-D is used to simultaneously evaluate the viscoelastic properties of the adsorbed wet matter and the coating. The bovine serum albumin (BSA) protein solution prepared at a concentration of 1 mg/mL in the phosphate buffered saline (PBS) flows through the surface of each of the antifouling substrates in Table 1, and the frequency change (Δf) and the dispersion change (ΔD) of QCM are recorded.

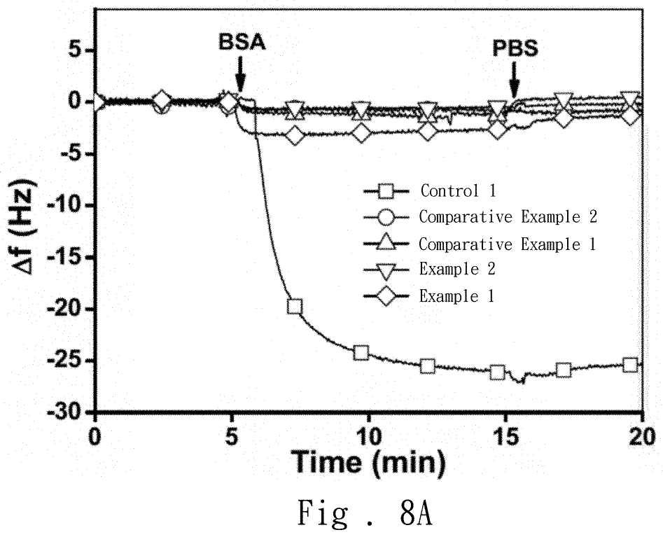

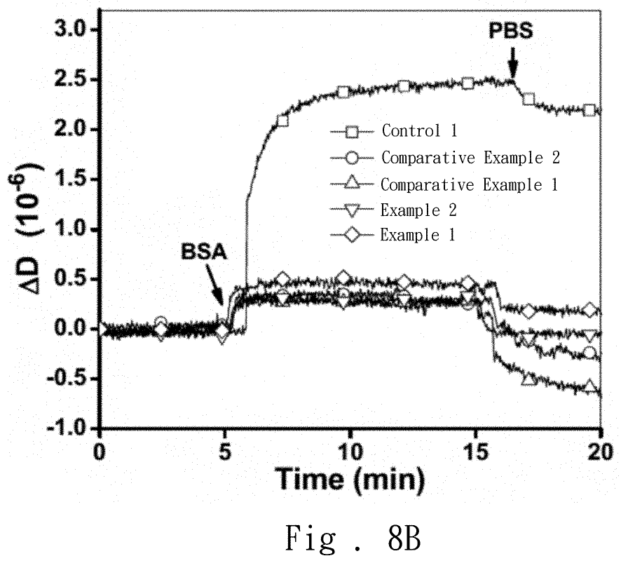

As shown in FIG. 8A, the frequency change (Δf) is tested after washing with PBS, showing that the degree of protein adsorption on all SBSi or SBSiT modified surfaces in the comparative examples and the embodiments are significantly lower than that of the Control 1.

The dissipation change (ΔD) is used to measure the properties of the coating associated with viscoelasticity. In FIG. 8B, after washing with PBS, ΔD of Embodiment 2 returns to zero, indicating no change in the viscoelastic properties of the coating. However, the ΔD values of Comparative Example 1 and Comparative Example 2 after washing are negative, indicating that the viscoelastic structure of the coating changes from hydration and softness to compactness and rigidity. This experiment proves the structural stability of the SBSiT coating.

The zwitterionic silatrane-based material of the present invention comprises a tricyclic caged silatranyl ring and transannular N→Si dative bond, thereby forming a strong antifouling coating, which not only breaks through the problem of surface aggregation and unevenness caused by easy hydrolysis of silane functional groups, but also maintains the property of good anti-non-specific adsorption of amphoteric double ions, and has a great potential as an amphoteric double-ion anti-fouling coating. Furthermore, the zwitterionic silatrane-based material of the present invention can resist adsorption of bacteria and proteins after testing, and has good structural stability after QCM-D testing, and is of a major development in the field of biomedical engineering.

What is claimed is:

1. A zwitterionic silatrane-based material comprising a structure as shown in Formula (I): 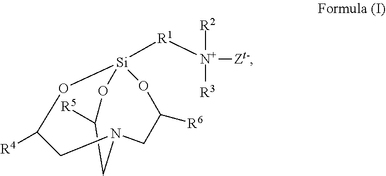
in which, Z^{t-} is R⁷—SO₃⁻, R⁷—CO₂⁻, R⁷—OPO₃²⁻, R⁷—PO₃²⁻ or R⁷—OP(═O)(R)O⁻; structures of R, R¹, R², R³, and R⁷ are independently selected from a group consisting of aliphatic, aromatic, branched, linear, cyclic, and heterocyclic groups; R⁴, R⁵ and R⁶ are independently selected from a group consisting of methyl (Me), H, ethyl (Et), and CH₂Cl.

2. The zwitterionic silatrane-based material according to claim 1, wherein Z^{t-} is R⁷—SO₃⁻.

3. The zwitterionic silatrane-based material according to claim 1, wherein R is an aliphatic series having 20 carbons or less.

4. The zwitterionic silatrane-based material according to claim 3, wherein R is methyl, ethyl, propyl or butyl.

5. The zwitterionic silatrane-based material according to claim 1, wherein R, R¹, R², R³, and R⁷ are independently selected from the group consisting of a C1-C20 alkyl group, a C2-C20 alkenyl group, and a C2-C20 alkynyl group.

6. The zwitterionic silatrane-based material according to claim 1, wherein R² and R³ are the same.

7. The zwitterionic silatrane-based material according to claim 1, wherein R² and R³ are different.

8. The zwitterionic silatrane-based material according to claim 1, wherein the zwitterionic silatrane-based material comprises a structure as shown in a Formula (II):

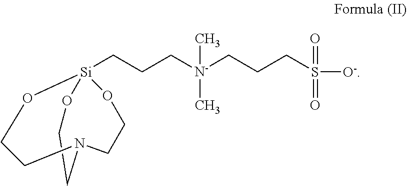

9. An antifouling substrate, comprising:
a base layer comprising a hydroxyl-containing surface; and
a coating layer which is formed by coating the hydroxyl-containing surface of the base layer with a zwitterionic silatrane-based material, such that Si—O—Si bonds are formed between the zwitterionic silatrane-based material and the base layer and then Si—O—Si bonds are grafted onto the base layer in order; the zwitterionic silatrane-based material comprising a structure as shown in the Formula (I): 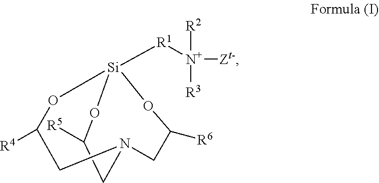
in which, Z^{t-} is R⁷—SO₃⁻, R⁷—CO₂⁻, R⁷—OPO₃²⁻, R⁷—PO₃²⁻ or R⁷—OP(═O)(R)O⁻; the structures of R, R¹, R², R³, and R⁷ are independently selected from the group consisting of aliphatic, aromatic, branched, linear, cyclic, and heterocyclic groups; and R⁴, R⁵ and R⁶ are independently selected from the group consisting of methyl (Me), H, ethyl (Et), and CH₂Cl.
